(19) United States
(12) Patent Application Publication
(10) Pub. No.: US 2003/0131082 A1
(43) Pub. Date: Jul. 10, 2003

(54) Wireless lan system, an access point apparatus and a managing method of a wireless lan system, which can determine the system manager without making the process for the authentication troublesome

(75) Inventor: Seiji Kachi, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/337,311

(22) Filed: Jan. 7, 2003

(30) Foreign Application Priority Data
Jan. 9, 2002 (JP) 002419/2002

(51) Int. Cl. G06F 15/177

(52) U.S. Cl. 709/220

(57) ABSTRACT

A wireless LAN system, includes an access point; and a plurality of terminals. The plurality of terminals are wirelessly connected to the access point. The access point has a server. The server treats a specified terminal of the plurality of terminals which accessed the server as a terminal of a system manager, and treats a terminal other than the specified terminal of the plurality of terminals as a terminal of a typical user whose access to the server is limited by the system manager.

### BACKGROUND OF THE INVENTION

1. Field of the Invention

The present invention relates to a data communication system, and more particularly to a wireless LAN (Local Area Network) system. Moreover, the present invention relates to an access point apparatus and a managing method of a wireless LAN system which are used in such a system.

2. Description of the Related Art

Recently, even at a little meeting in a company, each of participants carries a portable information terminal, for example, a note type PC (personal computer) terminal with him or her, and transmits and receives necessary information, in many cases. In this case, the information to be shared between the participants (for example, the information necessary for the meeting which is distributed to the participants, and data is stored as a file type) is passed to the respective participants by using a medium, for example, such as a compact flash (card memory) and the like. However, in a case of a larger number of participants, it is very troublesome to share a file by using the medium. So, in the above-mentioned meeting, LAN begins to be introduced in which the respective PC terminals of the participants can be communicably connected to each other through a network.

The LAN is basically provided with one server and a plurality of terminals (clients) that are mutually communicably connected thereto. It is classified into a wired LAN and a wireless LAN, depending on a difference of a transmission medium. In a case of the wired LAN, it is necessary to lay in advance a communication cable and the like. From the viewpoint of a cost, it is difficult to perform such construction on all rooms in a company, which are used for the meeting. Thus, the application to the meeting as mentioned above is difficult. On the contrary, in a case of the wireless LAN, it is not necessary to lay the communication cable and the like. The usage of a portably transiently-set access point (AP) enables a necessary network to be established at any location. Hence, the application to the meeting as mentioned above is easy.

A problem in an introduction of the wireless LAN is a security. The data treated at the meeting has a high secrecy. In order to avoid the data from being leaked to an external portion, it is necessary to limit an access from a third party to the wireless LAN by using any effective method. In order to carry out such a limit, a network OS (Operating System) of the wireless LAN usually has a security function.

The security function includes, for example, in addition to a network access control for admitting a log-in to a server only if a registered user presents a normal password, an access control to a file to limit an access right to a file to a particular user and the like, there is a control for limiting a user management to manage a user registration and the like, a system management and the like, to a system manager having a special right. The system manager can use this security function to allow only an admitted client to access to the server. Consequently, it is possible to limit an illegal access from a third party.

Also, in order to further improve the security, there is a method of limiting an illegal access from a third party by using a packet filter function to inspect an MAC (Medium Access Control) address. Here, the MAC address is physical addresses, which are a transmission destination address and a transmission source address. FIG. 1 is a schematic configuration view of a wireless LAN system for using the above-mentioned MAC address and then carrying out an access control.

In FIG. 1, it is provided with: an access point (AP) 101 serving as a base station of a wireless LAN; and a plurality of stations STAs 102-1 to 102-k serving as a mobile terminal station belonging to the AP 101. The wireless LAN system shown in FIG. 1 employs an infrastructure type defined in IEEE 802.11, and this constitutes a minimum unit (BBS (Basic Service Set) 104) of a wireless LAN network.

The AP 101 within the BBS 104 periodically broadcast-transmits a beacon frame containing information, through which each of the STAs 102-1 to 102-k is in synchronization with the AP 101, within the BBS 104. Each of the STAs 102-1 to 102-k within the BBS 104, which receives this beacon frame, performs an authentication request on the AP 101, when a communication is started. It can carry out the communication with the AP 101 after receiving the authentication admission done by the AP 101. By the way, in the system shown in FIG. 1, the AP 101 is illustrated as [portal]. This [portal] implies that a protocol conversion function into a LAN protocol except the IEEE 802.11 is added to the AP 101. The usage of this protocol conversion function enables the connection between the AP 101 and an Ethernet 105 serving as a wired LAN.

The authentication done by the AP 101 is a public key authentication, in which the packet filter function is used through the MAC address. The AP 101 has a public key management table in which a MAC address of an authenticated STA is registered, an AP secret key that is its own secret key, an AP public key that is a public key corresponding to it, and an AP user certificate to which it is written. Each of the STAs 102-1 to 102-k has an AP information management table in which the MAC address of the AP 101 receiving the public key authentication is registered, an STA secret key that is its own secret key, an STA public key that is a public key corresponding to it, and an STA user certificate to which it is written.

Each of the STAs 102-1 to 102-k receives the public key authentication from the AP 101 in accordance with the following procedure. The public key authentication of each of the STAs 102-1 to 102-k is carried out in the same procedure. Thus, in the following explanation, the procedure will be explained by exemplifying the STA 102-1.

The STA 102-1 checks whether or not the MAC address of the AP 101 trying to carry out a wireless communication is present in an AP information management table held by it. If the MAC address of the AP 101 is not present, the STA 102-1 performs a public key authentication request on the AP 101. If the MAC address of the AP 101 is present, the STA 102-1 performs a public key re-authentication request on the AP 101.

If the public key authentication request is done, the AP 101 receiving the request firstly transmits an AP user certificate to the STA 102-1. Next, the STA 102-1, after verifying the received AP user certificate, uses an AP public key appended to the AP user certificate, and transmits an encryption STA user certificate, in which an STA user certificate is encrypted, to the AP 101. Next, the AP 101 decodes the received encryption STA user certificate through the AP secret key, reproduces the original STA user certificate, and verifies this reproduced STA user certificate, and then uses the STA public key appended to this STA user certificate, and thereby encrypts a common key prepared for the STA 102-1 at a previous process, and further transmits this encrypted common key to the STA 102-1. Finally, the STA 102-1 decodes the received encrypted common key through the STA public key, and reproduces the original common key. Consequently, the STA 102-1 can use the reproduced public key to thereby carry out a frame encryption communication with the AP 101.

On the other hand, if the public key re-authentication request is done, the AP 101 receiving the request firstly checks whether or not both of the MAC address of the STA 102-1 and the STA public key are present in the public key management table held by it. If both are present, it generates a new common key to be specified for the STA 102-1, encrypts this generated new common key through the STA public key, and generates the encrypted new common key, and then transmits this generated encrypted new common key to the STA 102-1, and further reports the authentication admission. Next, the STA 102-1 decodes the received encrypted new common key through the STA secret key, and reproduces the original new common key. Consequently, the STA 102-1 can use the reproduced new common key to thereby carry out a frame encryption communication with the AP 101.

As mentioned above, the conventional wireless LAN is designed such that the predetermined system manager allows the access only for the user and thereby limits the illegal access from the third party. However, this case has the following problem. That is, the system manager is fixed. Thus, if the system manager does not participate in the meeting, participants of the meeting need to obtain the access admissions from the system manager, one by one. In addition, the access limit done by the system manager is usually done on the basis of an ID and a password. Hence, this has the following problem. That is, for each meeting, the participant needs to obtain the ID and the password from the system manager. Hence, the procedure necessary for the access becomes troublesome.

Such as the system shown in FIG. 1, the usage of the packet filter function to inspect the MAC address enables the security to be further improved. However, in the case of this system, it is necessary to carry out the authentication by using the public key and the secret key for each terminal (client). Thus, this has a problem that the process becomes troublesome.

Japanese Laid Open Patent Application (JP-A-Heisei, 7-79225) discloses the following network monitoring system. This is provided with: a network composed of a plurality of independent segments to which machines are connected and at least one communication device for connecting the segments to each other; and network monitoring devices that are installed at arbitrary positions on the segments, one by one, each having a first unit for recording a logical or physical identification information on the network of the machine whose connection on the segment is allowed by a network manager and a second unit for recording a detection time of the identification information issued from the machine, wherein each of the network monitoring devices has a control logic to tacitly admit an access to the network of the machine having the identification registered in the first unit, and when detecting an access to the network of the machine having the identification information that is not registered in the first unit, transmit the identification information together with the detection time to another network monitoring device, and thereby deduce an invasion route of the non-registered machine, in accordance with the difference between the detection times in the respective network monitoring devices.

Japanese Laid Open Patent Application (JP-A 2001-111543) discloses a system for updating an encryption key of a wireless LAN, as described below. This system for updating the encryption key of the wireless LAN is the system for updating the encryption key of the wireless LAN, in which it has one or more wireless access points (APs) on LAN, and the AP is wirelessly connected to one or more wireless access terminals (STAs), and data is encrypted between the STAs, and a communication (an encrypted communication) is carried out, wherein a key management server apparatus (SV) connected through LAN to the AP includes: an SV memory for storing k (k is one or more) encryption keys to be used for an encryption communication between the AP and the STA; and an encryption key generator for generating the encryption key and storing in the SV memory, and wherein the SV generates the encryption key by using the SV encryption key generator, stores in the SV memory, and controls the encryption key generator in accordance with a preset condition, and then updates the encryption key stored in the SV memory, and further distributes the updated encryption key to the AP and the STA.

### SUMMARY OF THE INVENTION

The present invention is accomplished in view of the above mentioned problems. Therefore, an object of the present invention is to provide a wireless LAN system, an access point apparatus and a managing method of a wireless LAN system, which can solve the above-mentioned respective problems and determine the system manager without making the process for the authentication troublesome.

In order to achieve an aspect of the present invention, a wireless LAN system, includes: an access point; and a plurality of terminals which are wirelessly connected to the access point, and wherein the access point has a server, and the server treats a specified terminal of the plurality of terminals which accessed the server as a terminal of a system manager, and treats a terminal other than the specified terminal of the plurality of terminals as a terminal of a typical user whose access to the server is limited by the system manager.

In this case, the specified terminal is a terminal which firstly accessed the server of the plurality of terminals which accessed the server.

Also in this case, the access point further includes a filter table, and wherein the server stores a MAC (Medium Access Control) address of each of the plurality of terminals which accessed the server and data indicating of an order of accessing the server of the terminal into the filter table, and wherein the server treats a terminal of which the order is 1 as the terminal of the system manager based on the data stored in the filter table.

Further in this case, each of the plurality of terminals outputs a packet to the access point as an outputting terminal, and wherein the packet includes the MAC address of the outputting terminal, and wherein the access point further includes a filtering unit which checks the MAC address included in the packet.

In this case, the server stores the MAC address of the terminal which the system manager gives a permission to access to the server of the plurality of terminals which accessed the server in the filter table.

Also in this case, the filtering unit passes the packet of which the MAC address is stored in the filter table.

Further in this case, the filtering unit passes the packet inputted to the server.

In this case, the specified terminal is a terminal from which data inputted to the server includes a specific data indicating of being registered as the terminal of the system manager of the plurality of terminals which accessed the server.

In order to achieve another aspect of the present invention, an access point apparatus of a wireless LAN system, includes: a server, and wherein the server treats a specified terminal of a plurality of terminals wirelessly connected to an access point of a wireless LAN system which accessed the server as a terminal of a system manager, and wherein the server treats a terminal other than the specified terminal of the plurality of terminals as a terminal of a typical user whose access to the server is limited by the system manager.

In this case, the specified terminal is a terminal which firstly accessed the server of the plurality of terminals which accessed the server.

Also in this case, the access point apparatus of a wireless LAN system further includes a filter table, and wherein the server stores a MAC (Medium Access Control) address of each of the plurality of terminals which accessed the server and data indicating of an order of accessing the server of the terminal into the filter table, and wherein the server treats a terminal of which the order is 1 as the terminal of the system manager based on the data stored in the filter table.

Further in this case, each of the plurality of terminals outputs a packet to the access point as an outputting terminal, and wherein the packet includes the MAC address of the outputting terminal, and wherein the access point apparatus further includes a filtering unit which checks the MAC address included in the packet.

In this case, the server stores the MAC address of the terminal which the system manager gives a permission to access to the server of the plurality of terminals which accessed the server in the filter table.

Also in this case, the filtering unit passes the packet of which the MAC address is stored in the filter table.

Further in this case, the filtering unit passes the packet inputted to the server.

In this case, the specified terminal is a terminal from which data inputted to the server includes a specific data indicating of being registered as the terminal of the system manager of the plurality of terminals which accessed the server.

In order to achieve still another aspect of the present invention, a managing method of a wireless LAN system, includes: (a) accessing a server of an access point of a wireless LAN system by a plurality of terminals which are wirelessly connected to the access point; (b) treating a specified terminal of the plurality of terminals which accessed the server as a terminal of a system manager; and (c) treating a terminal other than the specified terminal of the plurality of terminals as a terminal of a typical user whose access to the server is limited by the system manager.

In this case, the specified terminal is a terminal which firstly accessed the server of the plurality of terminals which accessed the server.

Also in this case, the managing method of a wireless LAN system further includes: (d) storing a MAC (Medium Access Control) address of each of the plurality of terminals which accessed the server and data indicating of an order of accessing the server of the terminal; and (e) treating a terminal of which the order is 1 as the terminal of the system manager based on the data stored.

Further in this case, the managing method of a wireless LAN system, further includes: (f) outputting a packet to the access point as an outputting terminal by each of the plurality of terminals, wherein the packet includes the MAC address of the outputting terminal; (g) checking the MAC address included in the packet; (h) storing the MAC address of the terminal which the system manager gives a permission to access to the server of the plurality of terminals which accessed the server; and (i) passing the packet of which the MAC address is stored at the (h).

In this case, the managing method of a wireless LAN system, further includes: (j) passing the packet inputted to the server.

Also in this case, the specified terminal is a terminal from which data inputted to the server includes a specific data indicating of being registered as the terminal of the system manager of the plurality of terminals which accessed the server.

In the present invention as mentioned above, for example, the user of the terminal trying to firstly access the server is treated as the system manager. Thus, any one of the participants of the meeting can be the system manager. Hence, differently from the conventional system in which the system manager is fixed in advance, the participants of the meeting need not obtain the access admission from the system manager, one by one.

Also, according to the present invention, it is designed such that the system manager is one of the participants of the meeting, and this system manager limits an access from a different terminal. The system manager usually allows only the participants of the meeting to access. Thus, the illegal access from the third party is rejected. Also, the authentication through the ID and the password is not required for the system manager to limit the access from the different terminal. Hence, the procedure necessary for the access is never troublesome, differently from the conventional technique.

### BRIEF DESCRIPTION OF THE DRAWINGS

FIG. 1 is a block diagram showing a schematic configuration of a conventional wireless LAN system;

FIG. 2 is a block diagram showing a schematic configuration of a wireless LAN system of an embodiment in the present invention;

FIG. 3 is a block diagram showing an embodiment of a wireless LAN system in the present invention;

FIG. 4 is a flowchart showing a filter processing procedure of a MAC address filter function in a system shown in FIG. 3;

FIG. 5 is a flowchart showing an operation of a Web server in the system shown in FIG. 3;

FIG. 6 is a view showing an example of a registration content of a filter table used in the system shown in FIG. 3;

FIG. 7 is a view showing another example of a registration content of a filter table used in the system shown in FIG. 3; and

FIG. 8 is a block diagram showing an embodiment of a computer system that can be applied to a wireless LAN system in the present invention.

### DESCRIPTION OF THE PREFERRED EMBODIMENTS

Embodiments of the present invention will be described below with reference to the attached drawings.

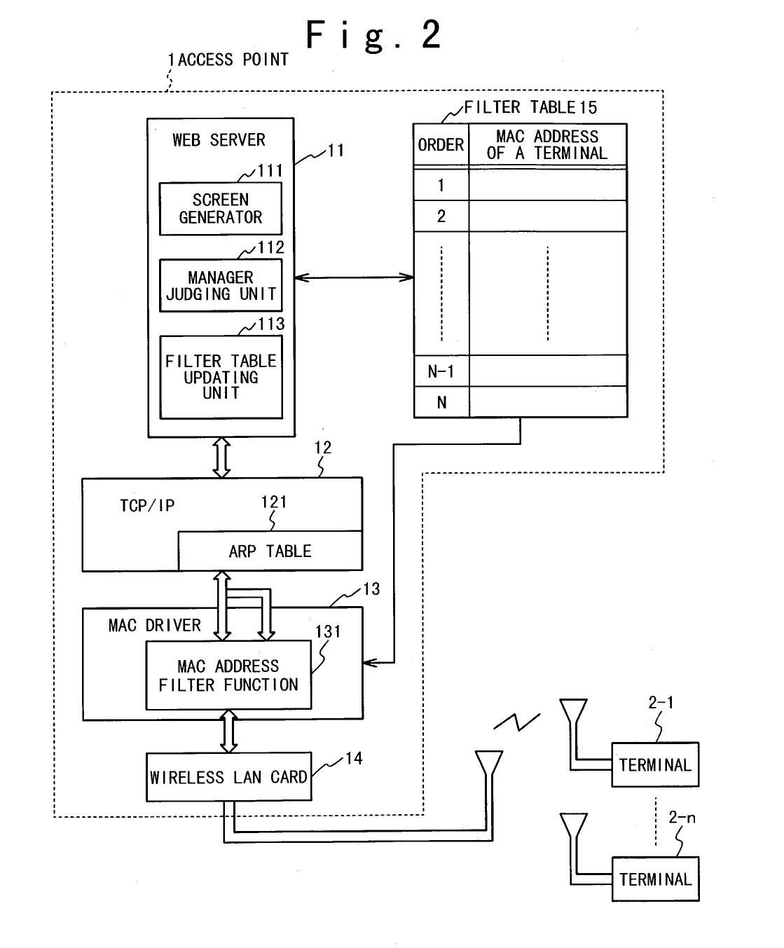

FIG. 2 is a block diagram showing a schematic configuration of a wireless LAN system of an embodiment in the present invention. This system includes: an access point (AP) 1 that is transiently installed at any location; and a plurality of terminals (clients) 2-1 to 2-n that can be mutually wirelessly communicated with this AP 1. Each of the terminals 2-1 to 2-n is a note type PC terminal having a predetermined wireless communication function (for example, a wireless LAN card).

The AP 1 has a Web server 11, a TCP/IP (Transmission Control Protocol/Internet Protocol) 12, a MAC driver 13, a wireless LAN card 14 and a filter table 15. A MAC address of a terminal carrying out a connection request to the Web server 11 is registered in the filter table 15, at an order of receiving a connection request. The registration of the MAC address in the filter table 15 is done by the Web server 11. However, let us suppose that any MAC address is not registered in the filter table 15, when the AP 1 is activated.

The TCP/IP 12, the MAC driver 13 and the wireless LAN card 14 are protocol stacks. The TCP/IP 12 is a communication protocol known in an Internet networking, and it enables the mutual connection between the AP 1 and the respective terminals 2-1 to 2-n. An ARP (Address Resolution Protocol) table 121 to attain a correspondence between an IP address and a MAC address is installed in this TCP/IP 12. This Web server 11 can use this ARP table 121 to thereby obtain the MAC address of the terminal carrying out the connection request from an IP address of an environmental variable contained in a packet sent out from each of the terminals 2-1 to 2-n.

The wireless LAN card 14 is intended to enable the wireless connection with the respective terminals 2-1 to 2-n. The MAC driver 13 is the device driver to control the wireless communication through this wireless LAN card 14, and it has a MAC address filter function 131 therein. Similarly to the Web server 11, the MAC address filter function 131 can use the ARP table 121 to thereby obtain the MAC address of the terminal carrying out the connection request from the IP address of the environmental variable contained in the packet sent out from each of the terminals 2-1 to 2-n, and it refers to the content of the current filter table 15 and the obtained MAC address to thereby allow/reject the pass of the packet. However, the MAC address filter function 131 unconditionally passes the packet to the Web server 11, among the packets from the terminals in which the MAC addresses are not registered in the filter table 15.

The Web server 11 has a screen generator 11, a manager judging unit 112 and a filter table updating unit 113. The filter table updating unit 113 registers the MAC address of the terminal performing the access request on the Web server 11 in the filter table 15 at the reception order. The MAC address of the firstly received terminal is registered in a column of an order 1 by the filter table updating unit 113. The manager judging unit 112 judges the MAC address firstly registered in the filter table 15, namely, the MAC address registered in the column of the order 1, as the terminal of the system manager, and then judges the MAC addresses registered as the other orders 2 to N as the terminals of the typical users. The screen generator 111 sends a report indicative of the system manager to the terminal judged as the system manager by the manager judging unit 112. Also, the screen generator 111, when the terminal except the system manager performs a first access request on the Web server 11, prompts the terminal of the system manager to display an access admission/inhibition setting screen on the terminal carrying out the access request and then carry out a setting work, and it also writes the set result to the filter table 15. Moreover, the screen generator 111 performs the display of the fact that the access admission is being requested of the system manager, the display of the result (the admission/inhibition) and the like, on the terminal carrying out the access request.

The operation of this wireless LAN system will be described below. Hereafter, the operation when the terminal 2-1 is defined as the terminal of the system manager and the other terminals are defined as the terminals of the typical users is exemplified and actually explained.

Immediately after the activation of the AP 1, when the terminal 2-1 performs the access request on the Web server 11 in the condition that any terminal does not perform the access request on the Web server 11, a packet from the terminal 2-1 is delivered through the wireless LAN card 14 to the MAC driver 13. At this time, nothing is registered in the filter table 15, and the packet transmitted from the terminal 2-1 is addressed to the Web server 11. Thus, the transmitted packet is delivered in its original state to the Web server 11 through the TCP/IP 12 without any limit from the filter table updating unit 113.

The Web server 11, when receiving the packet from the terminal 2-1, firstly uses the ARP table 121 from the IP address obtained from the environmental variable of the received packet, and obtains the MAC address. Next, the filter table updating unit 113 examines the registration content of the filter table 15. At this time, nothing is registered in the filter table 15. Thus, the filter table updating unit 113 registers the MAC address in the column of the order 1 of the filter table 15. Then, the screen generator 11 sends to the terminal 2-1, the report indicating that it is set as the system manager. This system manager setting report enables an owner of the terminal 2-1 to check that the owner is the system manager.

After the system manager is set as mentioned above, when the terminal except the terminal 2-1, for example, the terminal 2-n performs the access request on the Web server 11, the packet from the terminal 2-n is delivered through the wireless LAN card 14 to the MAC driver 13. At this time, the MAC address of the terminal 2-1 is only registered in the column of the order 1 of the filter table 15. The MAC address with regard to the terminal 2-n is not registered. Also, the packet transmitted from the terminal 2-n is addressed to the Web server 11. Thus, the transmission packet is delivered in its original state to the Web server 11 without any limit from the MAC address filter function 131.

The Web server 11, when receiving the packet from the terminal 2-n, firstly uses the ARP table 121 from the IP address obtained from the environmental variable of the received packet, and obtains the MAC address. Next, the filter table updating unit 113 examines the registration content of the filter table 15. The manager judging unit 112 judges whether or not the terminal 2-n transmitting the packet belongs to the system manager, on the basis of the registration content. Actually, the manager judging unit 112 judges whether or not it is the terminal of the system manager, depending on whether or not the obtained MAC address of the terminal 2-n coincides with the MAC address registered in the column of the order 1 of the filter table 15. At this time, the MAC address of the terminal 2-1 is registered in the column of the order 1 of the filter table 15. Thus, the manager judging unit 112 judges the access request from the terminal 2-n as the access request from the terminal except the system manager. Then, the screen generator 111 performs the display of the access admission/inhibition setting screen from the terminal 2-n, on the terminal 2-1 of the system manager, and also carries out the information display of [Requesting Admission to Manager] on the terminal 2-n.

On the access admission/inhibition setting screen displayed on the terminal 2-1, when the system manager carries out an setting input indicative of an access admission or an access inhibition, the screen generator 111 performs the information display of the set input result on the terminal 2-n, and the filter table updating unit 113 registers the set input result and the MAC address of the terminal 2-n in a next empty column of an order 2 of the filter table 15. For example, if the system manager carries out the setting input indicative of the access admission, the [Access Admission] is displayed on the terminal 2-n, and the [Access Admission] together with the MAC address of the terminal 2-n is registered in the column of the order 2 of the filter table 15. On the contrary, if the system manager carries out the setting input indicative of the access inhibition, the [Access Inhibition] is displayed on the terminal 2-n, and the [Access Inhibition] together with the MAC address of the terminal 2-n is registered in the column of the order 2 of the filter table 15. Here, it is assumed that the MAC address of the terminal 2-n and the set input result of the [Access Admission] are registered in the column of the order 2 of the filter table 15.

As for the other terminals 2-2 to 2-(n−1), after the system manager is set, if the access request is firstly performed on the Web server 11, in accordance with the procedure similar to that of the terminal 2-n, each MAC address and the set result of the access admission/inhibition by the system manager are registered in the filter table 15.

The operation on and after the second access to the Web server 11 from each of the terminals 2-1 to 2-n will be described below.

When the terminal 2-1 performs the second access request on the Web server 11, the packet from the terminal 2-1 is delivered through the wireless LAN card 14 to the MAC driver 13. At this time, the MAC address of the terminal 2-1 is registered in the column of the order 1 of the filter table 15. Moreover, this order 1 indicates the system manager. Thus, the MAC address filter function 131 transmits the transmission packet in its original state through the TCP/IP 12 to the Web server 11.

The Web server 11, when receiving the packet, firstly uses the ARP table 121 from the IP address obtained from the environmental variable of the received packet, and thereby obtains the MAC address. Next, the filter table updating unit 113 examines the registration content of the filter table 15, and the manager judging unit 112 judges whether or not the terminal 2-1 transmitting the packet is that of the system manager, in accordance with the registration content. At this time, the MAC address of the terminal 2-1 is registered in the column of the order 1 of the filter table 15. Thus, the manager judging unit 112 treats the terminal 2-1 transmitting the packet, as the terminal of the system manager. Consequently, the necessary data can be transmitted and received between the Web server 11 and the terminal 2-1.

On the other hand, when the terminal except the terminal 2-1, for example, the terminal 2-n performs the second access request on the Web server 11, the packet from the terminal 2-n is delivered through the wireless LAN card 14 to the MAC driver 13. At this time, the MAC address of the terminal 2-n is registered in the column of the order 2 of the filter table 15. Moreover, the set input result of the [Access Admission] is registered in the column of the order 2. Thus, the MAC address filter function 131 transmits the transmission packet in its original state through the TCP/IP 12 to the Web server 11. Incidentally, if the set input result registered in the column of the order 2 is the [Access Inhibition], the MAC address filter function 131 discards the packet from the terminal 2-n.

The Web server 11, when receiving the packet, firstly uses the ARP table 121 from the IP address obtained from the environmental variable of the received packet, and thereby obtains the MAC address. Next, the filter table updating unit 113 examines the registration content of the filter table 15, and the manager judging unit 112 judges whether or not the terminal 2-1 transmitting the packet is that of the system manager, in accordance with the registration content. The MAC address of the terminal 2-n is registered in the column of the order 2 of the filter table 15. Thus, the manager judging unit 112 treats the terminal 2-n transmitting the packet, as the terminal of the typical user whose access admission is allowed by the system manager. Consequently, the necessary data can be transmitted and received between the Web server 11 and the terminal 2-n.

As mentioned above, according to the wireless LAN system in this embodiment, the Web server 11 is designed so as to treat the firstly accessing terminal as the terminal of the system manager. Thus, any of the participants of the meeting can be the system manager.

Also, when the terminal that is not registered in the filter table 15 performs the access request on the Web server 11, the access admission/inhibition is always set by the set system manager. Thus, if the system manager allows the access only for the participants of the meeting, it is possible to protect the illegal access from the third party.

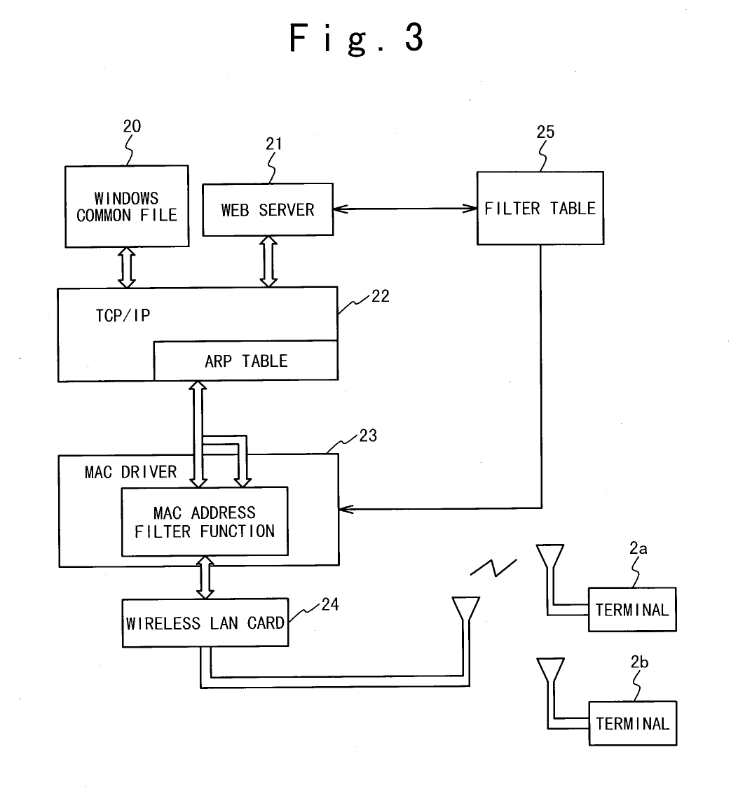

FIG. 3 is a block diagram showing an embodiment of the wireless LAN system in the present invention. The system in this embodiment is designed such that the system shown in FIG. 2 is applied to a system for performing an access limit on a [Windows] common file prepared on a PC including [Windows] (made by Microsoft Co., Ltd). This is provided with: an access point composed of a [Windows] common file 20, a Web server 21, a TCP/IP 22, a MAC driver 23, a wireless LAN card 24 and a filter table 25; and two terminals 2a, 2b which are wirelessly connected to it in a mutually communicable manner. The Web server 21, the TCP/IP 22, the MAC driver 23, the wireless LAN card 24 and the filter table 25 are basically equal to those of the system shown in FIG. 2.

The [Windows] common file 20 can be attained, for example, in UNIX by using an application referred to as SAMBA. Also, the Web server 21 can be attained by using an application referred to [Apache], in UNIX. The Web server 21 performs the display of a Web screen on a terminal requesting an access, and carries out a registration and a reference of a necessary data in and to the filter table 25, as described in the above-mentioned embodiment.

The two terminals 2a, 2b are the wireless LAN terminals, and respective IP addresses and MAC addresses are set as follows.

Terminal 2a: IP=192.168.1.1 MAC=000042-8A9C01

Terminal 2b: IP=192.168.1.2 MAC=000042-8A9C02

Here, [-] in the MAC address is inserted in order to make an address representation easily visible.

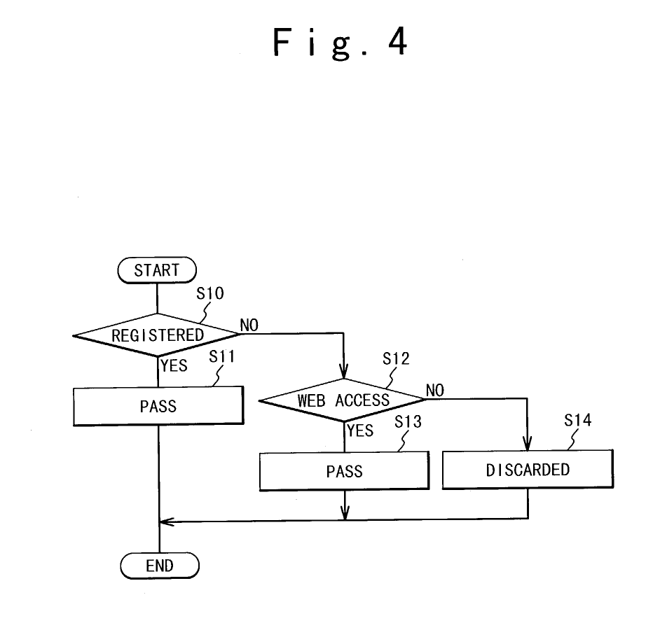

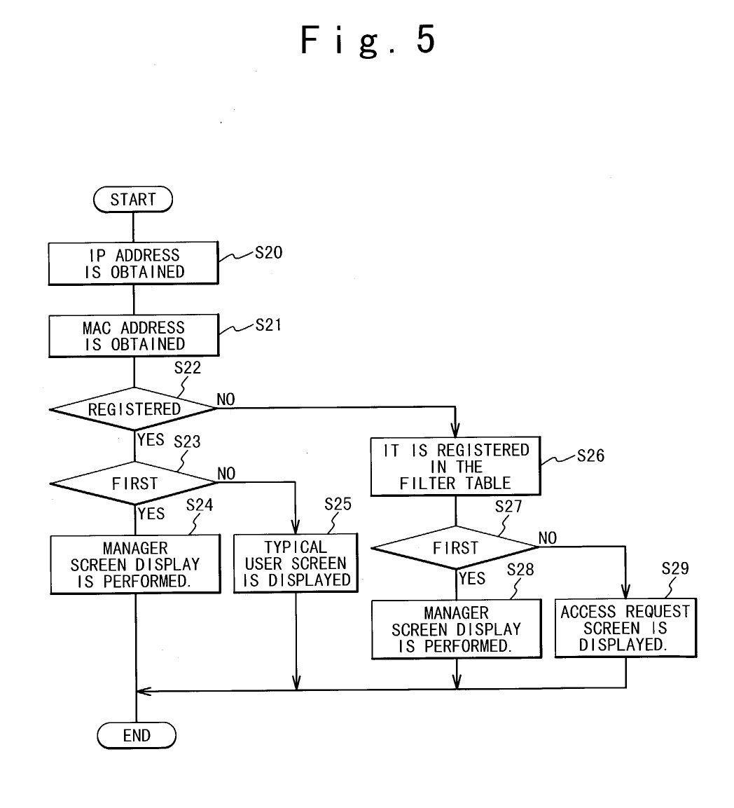

The operation of the system in this embodiment will be actually described below. FIG. 4 is a flowchart showing a filter processing procedure in a MAC address filter function of the MAC driver 23 in the system shown in FIG. 3. FIG. 5 is a flowchart showing the operation of the Web server 21 in the system shown in FIG. 3.

At first, the operation when the terminal 2a accesses the Web server 21 is described.

When the terminal 2a transmits a packet to the Web server 21, this transmitted packet is delivered through the wireless LAN card 24 to the MAC driver 23. In this MAC driver 23, the MAC address filter function is used to carry out the filtering function in accordance with the following procedure shown in FIG. 4.

At a step S10, it is judged whether or not the MAC address of the terminal 2a is registered in the filter table 25. Since the access to the Web server 21 from this terminal 2a is the first access, the MAC address of the terminal 2a is not registered in the filter table 25 at this time. Thus, the branch in a judgment at this step S10 is done as [N]. The operational flow proceeds to a next step S12. Incidentally, if the MAC address of the terminal 2a is registered in the filter table 25, the branch is done as [Y]. Hence, at a step S11, the packet is passed.

At the step S12, it is judged whether or not the access of the terminal 2a is the access to the Web server. The access of the terminal 2a is the access to the Web server. Thus, the branch in a judgment at the step S11 is done as [Y], and the packet is passed at a next step S13. Incidentally, if it is not the access to the Web server, the branch is done as [N], and the packet is discarded at a next step S14.

As mentioned above, after the packet from the terminal 2a receives the filtering process through the MAC address filter function, it is delivered through the TCP/IP 22 to the Web server 21.

The operation of the Web server 21 receiving the packet from the terminal 2a will be described below with reference to FIG. 5.

At a step S20, the IP address [192.168.1.1] of the terminal 2a is obtained from the environmental variable of the packet from the terminal 2a. At a next step S21, the ARP table within the TCP/IP 22 is used to obtain the MAC address [000042-8A9C01] of the terminal 2a from the obtained IP address. Next, at a step S22, it is judged whether or not the obtained MAC address is registered in the filter table 25. At this time, since the access from the terminal 2a is the first access, the MAC address of the terminal 2a is not registered in the filter table 25. Thus, the branch at the step S22 is done as [N]. At a next step S26, the registration in the filter table 25 is carried out. Here, the terminal 2a is assumed to be the terminal firstly accessing to the Web server. Then, the MAC address of the terminal 2a is registered in the column of the order 1 of the filter table 25.

When the MAC address of the terminal 2a is registered in the filter table 25 at the step S26, it is then judged at a step S27 whether or not the registration in the filter table 25 is the registration in the column of the order 1. At the step S26, the MAC address of the terminal 2a is registered in the column of the order 1 of the filter table 25. Thus, the branch at the step S27 is done as [Y]. At a next step S28, a manager screen display is performed on the terminal 2a. Consequently, a user of the terminal 2a can limit an admission/inhibition of an access from a different terminal as the system manager.

The operation when a terminal 2b accesses the Web server 21 will be described below.

When the terminal 2b transmits a packet to the Web server 21, this transmitted packet is also delivered through the wireless LAN card 24 to the MAC driver 23, similarly to the case of the terminal 2a. In this MAC driver 23, the MAC address filter function is used to carry out the filtering function in accordance with the following procedure (refer to FIG. 4).

At the step S10, it is judged whether or not the MAC address of the terminal 2b is registered in the filter table 25. Since the access to the Web server 21 from this terminal 2b is the first access, the MAC address of the terminal 2b is not registered in the filter table 25 at this time. Thus, the branch in the judgment at this step S10 is done as [N]. The operational flow proceeds to the next step S12.

At the step S12, it is judged whether or not the access of the terminal 2a is the access to the Web server 21. The access from this terminal 2a is the access to the Web server 21. Thus, the branch in the judgment at the step S11 is done as [Y], and the packet is passed at the next step S13.

As mentioned above, after the packet from the terminal 2b receives the filtering process through the MAC address filter function, it is delivered through the TCP/IP 22 to the Web server 21.

The operation of the Web server 21 receiving the packet from the terminal 2b will be described below (refer to FIG. 5).

At the step S20, the IP address [192.168.1.2] of the terminal 2b is obtained from the environmental variable of the packet from the terminal 2b. At the next step S21, the ARP table within the TCP/IP 22 is used to obtain the MAC address [000042-8A9C02] of the terminal 2b from the obtained IP address. Next, at the step S22, it is judged whether or not the obtained MAC address is registered in the filter table 25. At this time, since the access from the terminal 2b is the first access, the MAC address of the terminal 2b is not registered in the filter table 25. Thus, the branch at the step S22 is done as [N]. At the next step S26, the registration in the filter table 25 is carried out. The MAC address of the terminal 2a is already registered in the column of the order 1 of the filter table 25. Hence, the MAC address of the terminal 2b is registered in the column of the order 2.

When the MAC address of the terminal 2b is registered in the filter table 25 at the step S26, it is then judged at a step S27 whether or not the registration in the filter table 25 is the registration in the column of the order 1. At the step S26, the MAC address of the terminal 2b is registered in the column of the order 2 of the filter table 25. Thus, the branch at the step S27 is done as [N]. At a next step S29, an access request screen display with regard to the terminal 2b is performed on the terminal 2a. Consequently, the system manager who is the user of the terminal 2a can limit the admission/inhibition of the access for the terminal 2b, on the displayed access request screen.

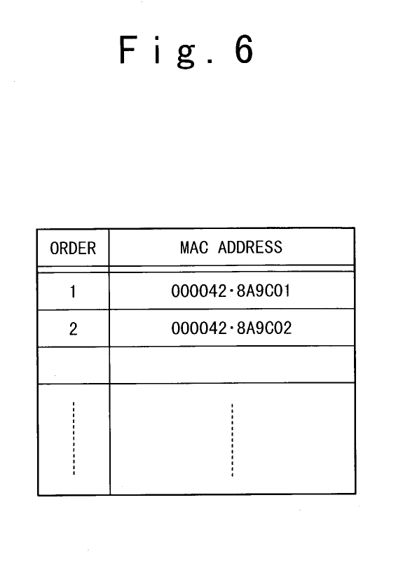

At the step S29, if the system manager sets the access inhibition for the terminal 2b, the Web server 21 removes the MAC address of the terminal 2b registered in the column of the order 2 at the step S26. If the system manager sets the access admission for the terminal 2b, the MAC address of the terminal 2b registered in the column of the order 2 at the step S26 is held at its original state. FIG. 6 shows one example of the registration content of the filter table 25 if the system manager sets the access admission for the terminal 2b at the step S29. In the example of FIG. 6, the MAC address [000042-8A9C01] of the terminal 2a is registered in the column of the order 1. Moreover, the MAC address [000042-8A9C02] of the terminal 2b is registered in the column of the order 2. This filter table 25 is used in the filtering process in the MAC address filter function. After that, all packets from the terminal 2b are passed through this MAC address filter function.

The access on and after the second time from the terminals 2a, 2b will be simply described below.

In the case of the access on and after the second time from the terminal 2a, the branch at the step S10 of FIG. 4 is done as [Y]. The packet from the terminal 2a is delivered to the Web server 21. In the Web server 21, the branch at the step S22 of FIG. 5 is done as [Y]. Whether or not it is registered in the column of the order 1 is judged at the next step S23. The MAC address of the terminal 2a is registered in the column of the order 1 of the filter table 25. Thus, the branch in this judgment is done as [Y]. At the next step S24, the manager screen display is again performed on the terminal 2a.

In the case of the access on and after the second time from the terminal 2b, the branch at the step S10 of FIG. 4 is done as [Y]. The packet from the terminal 2b is delivered to the Web server 21. In the Web server 21, the branch at the step S22 of FIG. 5 is done as [Y]. Whether or not it is registered in the column of the order 1 is judged at the next step S23. The MAC address of the terminal 2b is registered in the column of the order 2 of the filter table 25. Thus, the branch in this judgment is done as [N]. At the next step S25, a typical user screen display is again performed on the terminal 2b. Here, the typical user screen display is, for example, the information list with regard to the meeting. The user of the terminal 2b can obtain the necessary information by selecting a desirable item from the information list, for example, the [Windows] common file 20.

By the way, if the terminal 2b directly accesses the Windows common file 20 before obtaining the access admission from the system manager, the branch at the step S10 of FIG. 4 is done as [N]. Then, the branch at the next step S12 is [N]. Thus, the packet from the terminal 2b is discarded at the step S14.

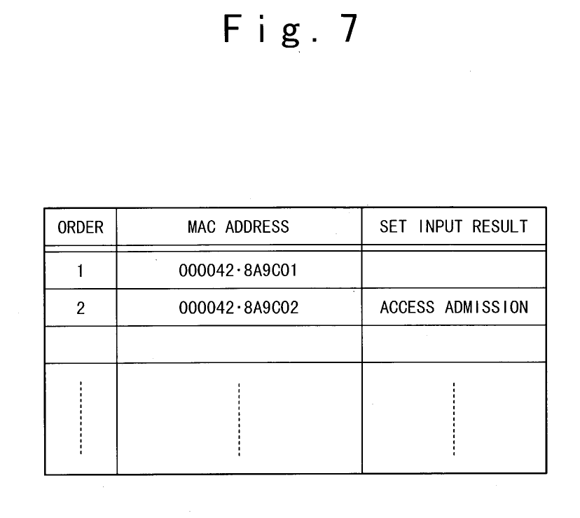

The configuration and the operation of the wireless LAN system in this embodiment as mentioned above are one example. Various modifications may be made thereto. For example, at the step S29 of FIG. 5, if the system manager who is the user of the terminal 2a performs the set input for limiting the access admission/inhibition on the terminal 2b on the displayed access request screen, the set input result may be registered in the filter table 25. FIG. 7 shows an example of the filter table 25 in that case. In the example of FIG. 7, the MAC address [000042-8A9C01] of the terminal 2a is registered in the column of the order 1. Moreover, the MAC address [000042-8A9C02] of the terminal 2b and the set input result [Access Admission] are registered in the column of the order 2. In this case, the MAC address filter function carries out the filtering process by referring to the set input result registered in the filter table 25.

The above-mentioned embodiments are designed such that after the AP activation, the terminal firstly accessing the Web server is set as the system manager. However, the present invention is not limited thereto. Any configuration can be employed if any of the participants of the meeting can be set as the system manager. For example, it may be designed such that when a certain terminal accesses the Web server, an access screen on which a check box indicating [This Terminal Is Registered As System Manger] is installed is displayed on the terminal, and the system manager is set for the terminal carrying out the access request in the condition that this check box is checked.

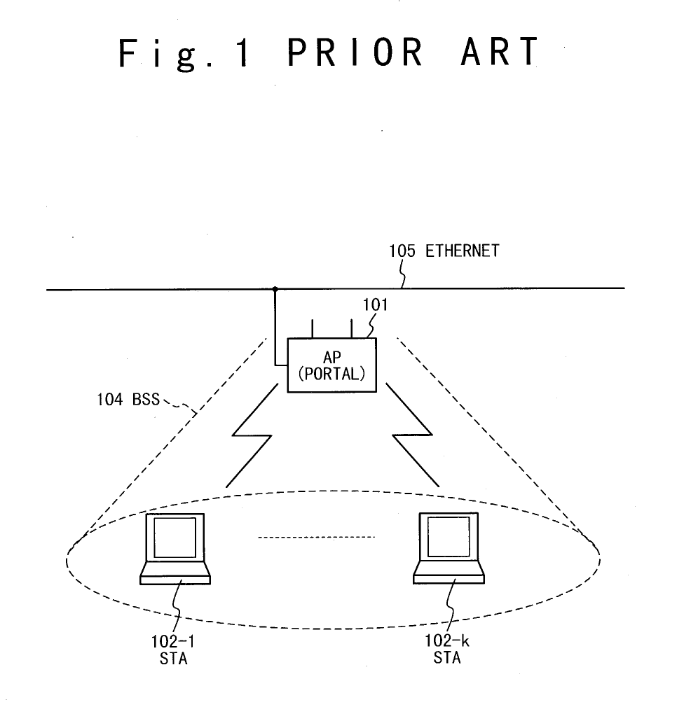

Also, the AP may be connected to another wired LAN. As the system in which the AP is connected to another wired LAN, for example, the system may be considered in which the configuration of the wireless LAN system in the present invention is applied to the conventional system shown in FIG. 1.

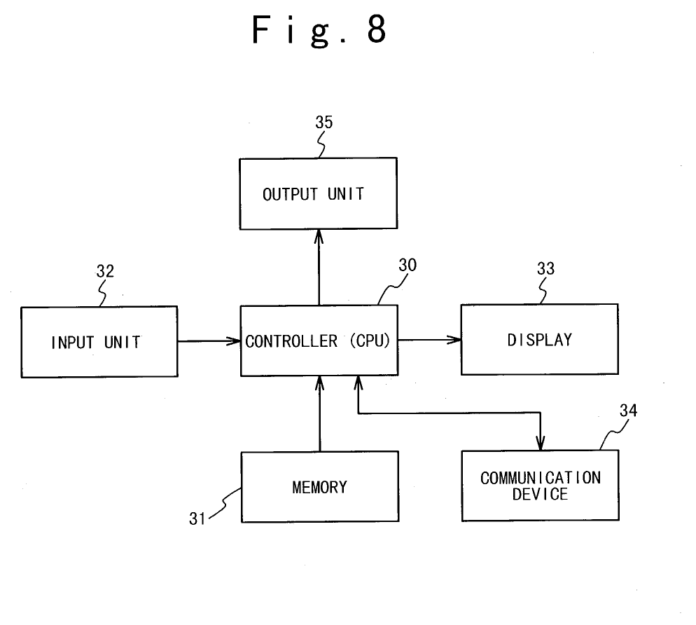

Also, the server, the MAC address filter function, the terminals and the like which are installed within the access point can be attained by the known computer system. FIG. 8 is a block diagram showing an embodiment of such a computer system. This computer system is provided with: a memory 31 for accumulating a program and the like; an input unit 32 such as a keyboard, a mouth and the like; a display 33 such as CRT, LCD and the like; a communication device 34, such as a modem and the like, for carrying out a communication with an external apparatus; an output unit 35 such as a printer and the like; and a controller (CPU) 30 for receiving an input from the input unit and controlling the operations of the communication device, the output unit and the display. For example, when the server of the system in FIG. 3 is configured by using this computer system, the program for executing the processing procedure shown in FIG. 5 is stored in advance in the memory 31. Then, the controller 30 reads out and executes the program. Incidentally, the program may be provided by using a recording medium (CD-ROM) (not shown) and the like.

As mentioned above, according to the present invention, the system manager is set from the participants of the meeting. Thus, it is not necessary to obtain the access admissions for the system managers who do not participate the meeting, one by one, differently from the conventional technique. Hence, it is possible to provide the easily usable system.

Also, according to the present invention, the system manager allows the access only for the terminal whose user is the participant of the meeting. Thus, it is possible to surely protect the illegal access from the third party.

Moreover, according to the present invention, the access limit done by the system manager does not require the authentication through the ID and the password. Thus, it is possible to simplify the processing procedure and reduce the processing time.

What is claimed is:

1. A wireless LAN system, comprising:
an access point; and
a plurality of terminals which are wirelessly connected to said access point, and
wherein said access point has a server, and said server treats a specified terminal of said plurality of terminals which accessed said server as a terminal of a system manager, and treats a terminal other than said specified terminal of said plurality of terminals as a terminal of a typical user whose access to said server is limited by said system manager.

2. The wireless LAN system according to claim 1, wherein said specified terminal is a terminal which firstly accessed said server of said plurality of terminals which accessed said server.

3. The wireless LAN system according to claim 2, wherein said access point further includes a filter table, and
wherein said server stores a MAC (Medium Access Control) address of each of said plurality of terminals which accessed said server and data indicating of an order of accessing said server of said terminal into said filter table, and
wherein said server treats a terminal of which said order is 1 as said terminal of said system manager based on said data stored in said filter table.

4. The wireless LAN system according to claim 3, wherein each of said plurality of terminals outputs a packet to said access point as an outputting terminal, and
wherein said packet includes said MAC address of said outputting terminal, and
wherein said access point further includes a filtering unit which checks said MAC address included in said packet.

5. The wireless LAN system according to claim 4, wherein said server stores said MAC address of said terminal which said system manager gives a permission to access to said server of said plurality of terminals which accessed said server in said filter table.

6. The wireless LAN system according to claim 5, wherein said filtering unit passes said packet of which said MAC address is stored in said filter table.

7. The wireless LAN system according to claim 5, wherein said filtering unit passes said packet inputted to said server.

8. The wireless LAN system according to claim 1, wherein said specified terminal is a terminal from which data inputted to said server includes a specific data indicating of being registered as said terminal of said system manager of said plurality of terminals which accessed said server.

9. An access point apparatus of a wireless LAN system, comprising:
a server, and
wherein said server treats a specified terminal of a plurality of terminals wirelessly connected to an access point of a wireless LAN system which accessed said server as a terminal of a system manager, and
wherein said server treats a terminal other than said specified terminal of said plurality of terminals as a terminal of a typical user whose access to said server is limited by said system manager.

10. The access point apparatus of a wireless LAN system according to claim 9, wherein said specified terminal is a terminal which firstly accessed said server of said plurality of terminals which accessed said server.

11. The access point apparatus of a wireless LAN system according to claim 10, further comprising a filter table, and
wherein said server stores a MAC (Medium Access Control) address of each of said plurality of terminals which accessed said server and data indicating of an order of accessing said server of said terminal into said filter table, and
wherein said server treats a terminal of which said order is 1 as said terminal of said system manager based on said data stored in said filter table.

12. The access point apparatus of a wireless LAN system according to claim 11, wherein each of said plurality of terminals outputs a packet to said access point as an outputting terminal, and
wherein said packet includes said MAC address of said outputting terminal, and
wherein said access point apparatus further comprising a filtering unit which checks said MAC address included in said packet.

13. The access point apparatus of a wireless LAN system according to claim 12, wherein said server stores said MAC address of said terminal which said system manager gives a permission to access to said server of said plurality of terminals which accessed said server in said filter table.

14. The access point apparatus of a wireless LAN system according to claim 13, wherein said filtering unit passes said packet of which said MAC address is stored in said filter table.

15. The access point apparatus of a wireless LAN system according to claim 13, wherein said filtering unit passes said packet inputted to said server.

16. The access point apparatus of a wireless LAN system according to claim 12, wherein said specified terminal is a terminal from which data inputted to said server includes a specific data indicating of being registered as said terminal of said system manager of said plurality of terminals which accessed said server.

17. A managing method of a wireless LAN system, comprising:
(a) accessing a server of an access point of a wireless LAN system by a plurality of terminals which are wirelessly connected to said access point;
(b) treating a specified terminal of said plurality of terminals which accessed said server as a terminal of a system manager; and
(c) treating a terminal other than said specified terminal of said plurality of terminals as a terminal of a typical user whose access to said server is limited by said system manager.

18. The managing method of a wireless LAN system according to claim 17, wherein said specified terminal is a terminal which firstly accessed said server of said plurality of terminals which accessed said server.

19. The managing method of a wireless LAN system according to claim 18, further comprising:
(d) storing a MAC (Medium Access Control) address of each of said plurality of terminals which accessed said server and data indicating of an order of accessing said server of said terminal; and
(e) treating a terminal of which said order is 1 as said terminal of said system manager based on said data stored.

20. The managing method of a wireless LAN system according to claim 19, further comprising:
(f) outputting a packet to said access point as an outputting terminal by each of said plurality of terminals, wherein said packet includes said MAC address of said outputting terminal;
(g) checking said MAC address included in said packet;
(h) storing said MAC address of said terminal which said system manager gives a permission to access to said server of said plurality of terminals which accessed said server; and
(i) passing said packet of which said MAC address is stored at said (h).

21. The managing method of a wireless LAN system according to claim 20, further comprising:
(j) passing said packet inputted to said server.

22. The managing method of a wireless LAN system according to claim 17, wherein said specified terminal is a terminal from which data inputted to said server includes a specific data indicating of being registered as said terminal of said system manager of said plurality of terminals which accessed said server.
